(19) United States
(12) Patent Application Publication
(10) Pub. No.: US 2013/0065069 A1
(43) Pub. Date: Mar. 14, 2013

(54) Electrodeposition of Hard Magnetic Coatings

(71) Applicants: Yun Li Liu, Solihull (GB); Carl P. Steinecker, South Lyon, MI (US); Trevor Pearson, West Midlands (GB); Duncan P. Beckett, Tamworth (GB)

(72) Inventors: Yun Li Liu, Solihull (GB); Carl P. Steinecker, South Lyon, MI (US); Trevor Pearson, West Midlands (GB); Duncan P. Beckett, Tamworth (GB)

(21) Appl. No.: 13/228,847

(22) Filed: Sep. 9, 2011

(51) Int. Cl. C25D 3/56; B32B 15/04

(52) U.S. Cl. 428/457; 205/258

(57) ABSTRACT

An aqueous electrolytic plating solution and a method of using the same for depositing a cobalt/nickel/phosphorus alloy on an electrically conductive substrate are provided. The aqueous electrolytic plating solution comprises: a) a source of nickel ions; b) a source of cobalt ions; c) a source of phosphite ions; d) an amino acid; and e) optionally, boric acid. The deposited cobalt/nickel/phosphorus alloy exhibits high coercivity and high remanence.

### FIELD OF THE INVENTION

The present invention relates generally to hard magnetic coatings of cobalt/nickel/phosphorus alloys that have desired properties, including coercivity and remanence.

### BACKGROUND OF THE INVENTION

Hard magnetic coatings have the properties of high coercivity and remanence. The term “hard magnet” refers to a magnetic material that can be permanently magnetized by applying a magnetic field. A good permanent magnet should produce a high magnetic field with a low mass, and should be stable against the influences which would demagnetize it.

The desirable properties of such magnets are typically stated in terms of the remanence and coercivity of the magnetic material. When a ferromagnetic material is magnetized in one direction, it will not relax back to zero magnetization when the imposed magnetizing field is removed. The amount of magnetization it retains at zero driving field is called its remanence. It must be driven back to zero by a field in the opposite direction; the amount of reverse driving field required to demagnetize it is called its coercivity. This ability to retain a magnetic “memory” has applications in many areas for data recording applications.

It is well known to record various types of information, either analog or digital, on apparatus employing ferromagnetic coatings on structures in a variety of forms such as tape, disks, drums, and the like. In these structures, a ferromagnetic coating is applied as a thin film on a non-ferromagnetic substrate. A broad variety of such magnetic coatings have been developed and used, and the magnetic characteristics of the coatings determine the type and amount of information of a given type which may be magnetically recorded thereon.

Hard magnetic coatings may be applied using techniques such as physical vapor deposition (PVD), chemical vapor deposition (CVD), electroless deposition and electrodeposition. In order to have the properties of high coercivity and remanence, the applied coatings must be ferromagnetic in nature and have a small grain size and a high degree of crystalline anisotropy, which can be obtained by depositing cobalt/nickel/phosphorus alloys. These cobalt/nickel/phosphorus alloys are hard, fine grained and may be deposited by either electroless or electrolytic deposition.

For industrial usage, it is desirable to apply these alloy coatings by electrodeposition as this method is both faster and less expensive than applying the coatings by means of electroless deposition. Electrodeposition of cobalt/nickel/phosphate alloys is known and various formulations have been described in the art. For example, formulations have previously been described based on a chloride electrolyte and using hypophosphite as a source of phosphorus. Another formulation is described in U.S. Pat. No. 3,950,234 to Faulkner et al., the subject matter of which is herein incorporated by reference in its entirety, and uses phosphite ions as a source of phosphorus in a sulfur-based electrolyte. It was found that the use of phosphite ions instead of hypophosphite ions greatly improves the stability of the electrolyte. While the electrolytes described in Faulkner provide an improvement in bath stability over the prior formulations containing hypophosphite, cobalt/nickel/phosphorus alloys deposited from these electrolytes have been found to exhibit variable magnetic properties, even when plated with the same plating parameters.

U.S. Pat. No. 7,439,733 to Donald, the subject matter of which is herein incorporated by reference in its entirety, describes the use of hard magnetic coatings for encoding data on cylinder rods used in pneumatic applications, which potentially has wide applications in the industry. However, there is no recognition of variability in the magnetic properties of the coating.

It would be highly desirable to provide an improved electrolyte bath composition for depositing hard magnetic materials having high coercivity and high remanence. The electrolyte bath compositions from which the hard magnetic materials may be deposited should also be highly stable so that chemical changes do not influence the properties of the coatings or decrease the efficacy of the baths. One of the key benefits of using a stable bath is that repetitive chemical analysis to adjust the bath composition can be greatly minimized.

The inventors of the present invention have discovered that the addition of amino acids to an electrolyte bath composition comprising nickel, cobalt and phosphorus ions is remarkably effective at stabilizing and improving the magnetic properties of the cobalt/nickel/phosphorus alloys thus produced.

### SUMMARY OF THE INVENTION

It is an object of the present invention to provide a stable electrolyte bath composition for electrodepositing cobalt/nickel/phosphorus alloy coatings.

It is another object of the present invention to provide an electrolyte bath composition capable of depositing cobalt/nickel/phosphorus alloy coatings having high coercivity and high remanence.

It is still another object of the present invention to produce alloy coatings by electrodeposition and having desired percentages of cobalt, nickel and phosphorus in the alloy coating composition.

To that end, in one preferred embodiment the present invention relates generally to an aqueous electrolytic plating solution comprising:

a) a source of nickel ions;

b) a source of cobalt ions;

c) a source of phosphite ions;

d) an amino acid; and

e) optionally, boric acid.

In another preferred embodiment, the present invention relates generally to a method of a method of electrodepositing a cobalt/nickel/phosphorus alloy on an electrically conductive substrate, the method comprising the steps of:

passing a plating current through the substrate as a cathode in an aqueous electrolytic plating solution, wherein the aqueous electrolytic plating solution comprises:

a) a source of nickel ions;

b) a source of cobalt ions;

c) a source of phosphite ions;

d) an amino acid; and

e) optionally, boric acid,

to deposit the cobalt/nickel/phosphorus alloy on the substrate.

The present invention aloes relates generally to the cobalt/nickel/phosphorus alloy coating deposited in accordance with the method of the invention.

### BRIEF DESCRIPTION OF THE DRAWINGS

FIG. 1 depicts the surface morphology of the CoNiP magnetic coating deposited using the electrolyte bath composition described in example 1.

### DETAILED DESCRIPTION OF THE PREFERRED EMBODIMENTS

The present invention relates generally to an aqueous electrolytic bath composition and a method of using the aqueous electrolytic bath composition to electrodeposit a cobalt/nickel/phosphorus alloy on a substrate having high coercivity and high remanence.

In a first embodiment, the present invention relates generally to an aqueous electrolytic plating solution comprising:

a) a source of nickel ions;

b) a source of cobalt ions;

c) a source of phosphite ions;

d) an amino acid; and

e) optionally, boric acid.

The source of nickel and cobalt ions is preferably a salt of either sulfate or chloride although other salts may be used including, for example, sulfamate and methane sulfonate salts of nickel and cobalt. The concentration of nickel ions in the bath is preferably between about 10 to about 30 g/L and the concentration of cobalt ions is preferably between about 5 to 15 g/L. In addition, it is desirable that the ratio of nickel ions to cobalt ions in the bath is between about 1:1 to about 6:1, more preferably between about 2:1 to 3:1. The ratio of nickel to cobalt is important so that phosphite ions (otherwise known as ortho-phosphite ions) may be employed as the sole source of phosphorus in the solution to deposit alloys of cobalt, nickel and phosphorus having the desired coercivity and remanence solely by the electrolytic action of the plating current.

The source of phosphite ions is preferably sodium phosphite, potassium phosphite or phosphorous acid, although other suitable sources of phosphite ions would also be usable in the practice of the invention. In addition, it is desirable that the plating bath is free of either hypophosphite ions or phosphate ions, so that phosphite ion is the sole source of phosphorus in the bath. The elimination of hypophosphite ion from the plating bath enables a substantial increase in the ability to independently control coercivity and remanence. The concentration of phosphite ions in the bath is preferably between about 2 to about 9 g/L.

The amino acid is added to the electroplating bath composition to maintain consistent deposit properties. The amino acid preferably has the formula:

H₂N—CHR—CO₂X

Wherein R is H or a C₁ to C₄ alkyl and X is H or an alkali metal cation.

Suitable amino acids include, but are not limited to glycine, alanine, valine, leucine, iso-leucine and salts of these amino acids (i.e., sodium glycinate). The concentration of the amino acid in the electrolytic bath composition is preferably between about 0.1 and about 15 g/L, more preferably between about 2 and about 8 g/L, and most preferably between about 4 and about 6 g/L.

The bath may additionally contain other salts to improve the conductivity of the electrolytic bath composition. Examples of these salts include, but are not limited to, ammonium chloride, ammonium sulfate, potassium sulfate, potassium chloride, sodium chloride and sodium sulfate. If used, the salts may preferably be present in the electrolytic bath composition at a concentration of between about 0 g/L up to the limit of solubility, more preferably between about 10 and about 15 g/L.

The use of boric acid in the electrolytic bath composition is also desirable, but not essential. Boric acid is a cathode buffer that aids in practical operation of the electrolytic bath composition. If used, boric acid may be present in the electrolytic bath composition at a concentration of between about 0 g/L to the limit of solubility, more preferably between about 25 and about 35 g/L.

The present invention also relates generally to a method of electrodepositing a cobalt/nickel/phosphorus alloy on an electrically conductive substrate, the method comprising the steps of:

passing a plating current through the substrate as a cathode in an aqueous electrolytic plating solution, wherein the aqueous electrolytic plating solution comprises:

a) a source of nickel ions;

b) a source of cobalt ions;

c) a source of phosphite ions;

d) an amino acid; and

e) optionally, boric acid,

to deposit the cobalt/nickel/phosphorus alloy on the electrically conductive substrate.

The operating temperature of the aqueous electrolytic plating solution is typically in the range of about 15 to about 35° C., more preferably between about 20 and about 30° C. The current density of the aqueous electrolytic plating solution is typically between about 0.25 and about 1.5 amps per square decimeter (ASD), more preferably between about 0.5 and about 1.0 ASD. Both temperature and current density have been found to have an effect on the magnetic properties of the deposited cobalt/nickel/phosphorus alloy.

In addition, agitation has a considerable influence on the composition and magnetic properties of the deposit and strong agitation tends to lead to deposits with poor coercivity and remanence. Therefore, it is desirable that either no or only very mild agitation is used during the plating process. Thus, if agitation is used, the amount should be controlled to maximize, or at least not impair, the remanence and coercivity of the deposit produced.

The pH of the aqueous electrolytic plating solution is preferable maintained within the range of about 3 to about 4, more preferably between about 3.3 and about 3.5. If necessary, the pH may be maintained by adding at least one of sodium carbonate, sodium bicarbonate, potassium carbonate, nickel carbonate or sulfuric acid. The pH is maintained within this range so that the high coercivity can be achieved and to control magnetic properties of the deposited coating.

The metal content of the aqueous electrolytic plating solution is preferably maintained by the use of soluble anodes of cobalt and nickel. The anodes may consist of, for example, a mixture of nickel and cobalt pieces in the appropriate proportions contained in a titanium basket, or a dual rectification system where about 80% of the plating current is passed through cobalt anodes and 20% of the current is passed through the nickel anodes.

In a preferred embodiment, the cobalt/nickel/phosphorus alloy deposited on the electrically conductive substrate has a composition of between about 65 to about 85 wt % cobalt, about 13% to about 33 wt % nickel and about 1.2 to about 2.5 wt % phosphorus. In addition, the deposited alloy preferably has a coercivity in the range of about 344 to about 741 Oersteds and a remanence of between about 0.8 to about 1.17.

The invention will now be exemplified by reference to the following non-limiting examples:

### Comparative Example 1

A sample was deposited from the bath having a cobaltous ion concentration of 7.5 g/L, a nickel ion concentration of 40 g/L, a nickel to cobalt ratio of 5.33, a sodium phosphite concentration of 7.5 g/L, a sodium formate concentration of 20 g/L, a boric acid concentration of 20 g/L liter and a sodium sulfate concentration of 10 g/L and with a pH adjusted to 4.25. Plating was conducted at 80° F. to produce a coating 7.5 microinches thick.

Current density was 50 amperes per square foot (ASF) with pulses 0.10 seconds long and a time interval of 5.0 seconds between pulses.

The retentivity of the samples was about 4800 gauss and the coercivity was 510 Oersted,

### Comparative Example 2

700 ml of water, 47.6 grams of cobalt sulfate, 95.2 grams of nickel sulfate, 5 grams of phosphorus acid, 13.4 grams of ammonium chloride and 30 grams of boric acid were mixed together with stirring to form a mixture. 50% sodium hydroxide was slowly added into the mixture until the pH reached 3.4. The rest of the water was added into the mixture until the volume of the mixture reached 1 liter.

Plating was carried out on a pure brass panel (33 mm×75 mm) at room temperature for 2.5 hours. Current density was 0.75 ASD. The deposition thickness was about 15 μm.

The retentivity of the sample was about 5000 gauss, the coercivity was 344 Oersted and the remanence was 0.8.

### Example 1

700 ml of water, 47.6 grams of cobalt sulfate, 95.2 grams of nickel sulfate, 5 grams of phosphoric acid, 13.4 grams of ammonium chloride, 30 grams of boric acid and grams of glycine were mixed together with stirring to form a mixture. 50% sodium hydroxide was slowly added into the mixture until the pH reached 3.4. The rest of the water was added into the volume of the mixture reached 1 liter.

Thereafter, plating was carried out on a pure brass panel (33 mm×75 mm) at room temperature for 2.5 hours at a current density of 0.75 ASD. The deposition thickness was about 15 μm. The retentivity of the sample was about 5000 gauss, the coercivity was 714 Oersted and the remanence was 1.15.

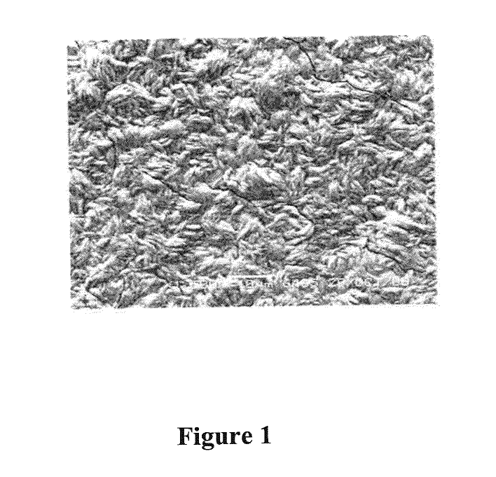

The surface morphology of the CoNiP magnetic coating of Example 1 is shown in FIG. 1. As seen in FIG. 1, the sample has a dendritic, tapered columnar structure. Examples 2-8 are provided below in Table 1.

TABLE 1
Examples 2-8 of the invention

| | Ex. 2 | Ex. 3 | Ex. 4 | Ex. 5 | Ex. 6 | Ex. 7 | Ex. 8 |
|---|---|---|---|---|---|---|---|
| Cobalt sulfate (g/L) | 47.6 | 47.6 | 47.6 | 47.6 | 71.4 | 47.6 | 4.6 |
| Nickel sulfate (g/L) | 95.2 | 95.2 | 95.2 | 142.8 | 95.2 | 95.2 | 95.2 |
| Phosphorus acid (g/L) | 5 | 5 | 9 | 5 | 5 | 5 | 5 |
| Ammonium chloride (g/L) | 13.4 | 13.4 | 13.4 | 13.4 | 13.4 | 13.4 | 13.4 |
| Boric acid (g/L) | 30 | 30 | 30 | 30 | 30 | 30 | 30 |
| Glycine (g/L) | 15 | | 5 | 5 | 5 | 5 | 5 |
| B-Alanine (g/L) | | 15 | | | | | |
| pH | 3.4 | 3.4 | 3.4 | 3.4 | 3.4 | 4 | 3.4 |
| Temperature (° C.) | 25 | 25 | 25 | 25 | 25 | 25 | 35 |
| Current density (ASD) | 0.75 | 0.75 | 0.75 | 0.75 | 0.75 | 0.75 | 0.75 |
| Coercivity (Oe) | 669 | 530 | 741 | 610 | 529 | 641 | 527 |
| Remanence (emu) | 0.81 | 0.95 | 0.85 | 1.13 | 1.08 | 0.9 | 1.17 |

Thus it can be seen that the aqueous electrolytic plating solutions described herein in accordance with the present invention produce cobalt/nickel/phosphorus alloy coatings having the desirable properties of high coercivity and high remanence and with stable magnetic properties.

What is claimed is:

1. An aqueous electrolytic plating solution comprising:
a) a source of nickel ions;
b) a source of cobalt ions;
c) a source of phosphite ions;
d) an amino acid; and
e) optionally, boric acid.

2. The aqueous electrolytic plating solution according to claim 1, wherein the source of nickel ions is a nickel salt.

3. The aqueous electrolytic plating solution according to claim 2, wherein the nickel salt comprises nickel sulfate or nickel chloride.

4. The aqueous electrolytic plating solution according to claim 1, wherein the concentration of nickel ions is between about 10 to about 30 g/L.

5. The aqueous electrolytic plating solution according to claim 1, wherein the source of cobalt ions is a cobalt salt.

6. The aqueous electrolytic plating solution according to claim 5, wherein the cobalt salt comprises cobalt sulfate or cobalt chloride.

7. The aqueous electrolytic plating solution according to claim 1, wherein the concentration of cobalt ions is between about 5 to about 15 g/L.

8. The aqueous electrolytic plating solution according to claim 1, wherein the ratio of nickel ions to cobalt ions is between about 1:1 to about 6:1.

9. The aqueous electrolytic plating solution according to claim 8, wherein the ratio of nickel ions to cobalt ions is between about 2:1 to about 3:1.

10. The aqueous electrolytic plating solution according to claim 1, wherein the source of phosphite ions comprises sodium phosphite, potassium phosphite or phosphorus acid.

11. The aqueous electrolytic plating solution according to claim 1, wherein the concentration of phosphite ions is between about 2 to about 9 g/L.

12. The aqueous electrolytic plating solution according to claim 1, wherein the amino acid has the formula:
H₂N—CHR—CO₂X
wherein R is H or a (C₁ to C₄ alkyl and X is H or an alkali metal cation.

13. The aqueous electrolytic plating solution according to claim 12, wherein the amino acid is one or more of glycine, alanine, valine, leucine, iso-leucine, or salt of any of the foregoing.

14. The aqueous electrolytic plating solution according to claim 13, wherein the amino acid is glycine.

15. The aqueous electrolytic plating solution according to claim 12, wherein the concentration of the amino acid is between about 0.1 g/L to about 15 g/L.

16. The aqueous electrolytic plating solution according to claim 15, wherein the concentration of the amino acid is between about 2 to about 8 g/L.

17. The aqueous electrolytic plating solution according to claim 16, wherein the concentration of the amino acid is between about 4 and about 6 g/L.

18. The aqueous electrolytic plating solution according to claim 1, wherein the boric acid is present at a concentration of between about 25 to 35 g/l.

19. The aqueous electrolytic plating solution according to claim 1, further comprising one or more salts capable of increasing the conductivity of the aqueous electrolytic plating solution.

20. The aqueous electrolytic plating solution according to claim 19, wherein the one or more salts are selected from the group consisting of ammonium chloride, ammonium sulfate, potassium sulfate, potassium chloride, sodium chloride and sodium sulfate.

21. The aqueous electrolytic plating solution according to claim 1, wherein the plating solution has a pH of between about 3 and 4.

22. A method of electrodepositing a cobalt/nickel/phosphorus alloy on an electrically conductive substrate, the method comprising the steps of:
passing a plating current through the substrate as a cathode in an aqueous electrolytic plating solution, wherein the aqueous electrolytic plating solution comprises:
a) a source of nickel ions;
b) a source of cobalt ions;
c) a source of phosphite ions;
d) an amino acid; and
e) optionally, boric acid,
to deposit the cobalt/nickel/phosphorus alloy on the electrically conductive substrate.

23. The method according to claim 23, wherein the source of nickel ions comprises nickel sulfate or nickel chloride.

24. The method according to claim 22, wherein the concentration of nickel ions is between about 10 to about 30 g/L.

25. The method according to claim 22, wherein the source of cobalt ions comprises cobalt sulfate or cobalt chloride.

26. The method according to claim 22, wherein the concentration of cobalt ions is between about 5 to about 15 g/L.

27. The method according to claim 22, wherein the ratio of nickel ions to cobalt ions is between about 1:1 to about 6:1.

28. The method according to claim 27, wherein the ratio of nickel ions to cobalt ions is between about 2:1 to about 3:1.

29. The method according to claim 22, wherein the source of phosphite ions comprises sodium phosphite, potassium phosphite or phosphorus acid.

30. The method according to claim 22, wherein the concentration of phosphite ions is between about 2 to about 9 g/L.

31. The method according to claim 22, wherein the amino acid has the formula:
H₂N—CHR—CO₂X
wherein R is H or a C₁ to C₄ alkyl and X is H or an alkali metal cation.

32. The method according to claim 31, wherein the amino acid is one or more of glycine, alanine, valine, leucine, iso-leucine, or salt of any of the foregoing.

33. The method according to claim 32, wherein the amino acid is glycine.

34. The method according to claim 31, wherein the concentration of the amino acid is between about 0.1 g/L to about 15 g/L.

35. The method according to claim 34, wherein the concentration of the amino acid is between about 2 to about 8 g/L.

36. The method according to claim 22, wherein the boric acid is present at a concentration of between about 25 to 35 g/1.

37. The method according to claim 22, further comprising one or more salts capable of increasing the conductivity of the aqueous electrolytic plating solution, wherein the one or more salts are selected from the group consisting of ammonium chloride, ammonium sulfate, potassium sulfate, potassium chloride, sodium chloride and sodium sulfate.

38. The method according to claim 22, wherein the aqueous electrolytic plating solution has a pH1 of between about 3 and 4.

39. The method according to claim 22, wherein the plating current has a current density of between about 0.25 and about 1.5 ASD.

40. The method according to claim 22, wherein the aqueous electrolytic plating solution is maintained at a temperature of between about 15° C. to about 35° C.

41. An article coated by the process of claim 22.

42. The article according to claim 41, wherein the cobalt/nickel/phosphorus alloy has a composition of between about 65 wt. % to about 85 wt. % cobalt, about 13 wt. % to about 33 wt. % nickel and about 1.2 wt. % to about 2.5 wt. % phosphorus.

43. The article according to claim 41, wherein the coating has a coercivity of about 344 to about 741 Oersteds.

44. The article according to claim 41, wherein the coating has a remanence of about 0.8 to about 1.17.
